(19) United States
(12) Patent Application Publication
(10) Pub. No.: US 2005/0094223 A1
(43) Pub. Date: May 5, 2005

(54) Scanning apparatus having adjusting means for optical scanning module

(76) Inventor: Hai-Tao Ma, Wuzhong City (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/982,683

(22) Filed: Nov. 4, 2004

(30) Foreign Application Priority Data
Nov. 5, 2003 (TW) 092131002

(51) Int. Cl. H04N 1/024

(52) U.S. Cl. 358/486

(57) ABSTRACT

A scanning apparatus having an adjusting means is provided to allow the optical scanning module against the platen. The adjusting means is assembled with the carriage that carries the optical scanning module. The adjusting means at least comprises a roller and a rotated portion, wherein the roller tightly contacts the rotated portion. When the carriage is moving (during a scanning operation), the roller is rotating and friction (between the roller and the rotating assembly) causes the rotated portion to turn until contacting with the bottom surface of the optical scanning module, thereby allowing the optical scanning module against the platen.

This application claims the benefit of Taiwan application Serial No. 92131002, filed Nov. 5, 2003, the subject matter of which is incorporated herein by reference.

### BACKGROUND OF THE INVENTION

1. Field of the Invention

The invention relates in general to a scanning apparatus having an adjusting means for adjusting the position of the optical scanning module, and more particularly to the adjusting means for lifting the optical scanning module up and against the platen during the scanning operation.

2. Description of the Related Art

In the Age of high technology, scanner has been required in the modern life due to its great functions of scanning the original drafts, such as the pictures, the photos and the documents, and then transforming and saving the image as the digital files. It is a very convenient way for the users to keep or find the original drafts. The structure and the principle of the scanner are described below.

A conventional optical scanner has a transparent platen for placing an original to be scanned document. A moving carriage assembly and the drive mechanisms are positioned underneath the transparent platen. The moving carriage assembly, including an optical scanning module supported by a carriage, contains the optical and electronic or reflective components, and moves across the complete length of the document during scanning. The components commonly used for the carriage assembly are the light source, the reflector, the lens and the photo-electronic sensing device. Drive mechanisms for moving the carriage assembly are varied. During scanning, the light emitted from the light source is reflected by the original to be scanned document, and then further reflected by the lens and focused on the photo-electronic sensing device by the lens. Afterward, the light signal received by the photo-electronic sensing device is converted into electronic signals, and then produce machine-readable data, which is representative of the image of the original document. The photo-electronic sensing device can be any device capable of converting the light signal into the electric signal, such as charged coupled device (CCD) or contact image device (CIS).

During scanning, the carriage assembly is required to move against the transparent platen, particularly the carriage assembly using contact image device (CIS) (which has a short scene depth of about 0.3 mm) as the photo-electronic sensing device. FIG. 1 is an explosive view schematically showing a conventional structure of the contact image device (CIS) module and the carriage apparatus. The transparent platen 10 is used for placing an original to be scanned document. Under the transparent platen 10, the optical scanning module 12 is loaded in the carriage 14 which is positioned on a shaft (not shown) by a connecting means 16, and the drive mechanism (not shown) drives the carriage 14 to move along the scanning direction on the shaft. Also, a spring 18 is interposed between the optical scanning module 12 and the carriage 14. The spring 18 provides an upward elastic force to lift the optical scanning module 12 up until contacting the bottom surface of the transparent platen 10, thereby making the optical scanning module 12 move against the transparent platen 10 during a scanning operation.

As be known, the degree of fidelity with which the information presented by the to be scanned document is recorded depends on the accuracy with which the moving carriage assembly is guided during the scanning operation. The reproduction is liable to be impaired even by small changes in either the direction of relative scanning movement or the spacing between the document and the optical scanning module 12 from one moment to another in the scanning operation. The conventional design with a spring 18 between the scanning apparatus and the carriage, however, is difficult to keep the optical scanning module 12 in balance, particularly in a scanning movement. It is also difficult to precisely and firmly locate the spring 18 at the center of the carriage 14. In practice it would be desirable to design not only an easy to be assembled but also a more reliable and stable structure to lift the scanning module up for contacting with the platen, thereby obtaining an optimal scanning image result with a high standard of accuracy.

### SUMMARY OF THE INVENTION

It is therefore an object of the invention to provide a scanning apparatus having an adjusting mean for adjusting the position of the optical scanning module. In the invention, one of two objects in contact rotates simultaneously makes the other object rotates due to friction between two objects. Therefore, an upward force directly or indirectly acts on the optical scanning module and lifts it up and against the platen.

The invention achieves the objects by providing a scanning apparatus having an adjusting mean for adjusting the position of the optical scanning module. The scanning apparatus comprises a platen for placing a to-be-scanned document; an optical scanning module disposed under the platen for scanning and acquiring an scanned image of the to-be-scanned document; and a carriage for carrying the optical scanning module to move backward and forward in the scanning apparatus. The carriage has an adjusting means, comprising a roller and a rotated portion, to change the position of the optical scanning module.

When the roller is rotating, friction between the rotated portion and the roller makes the rotated portion rotate until touching the optical scanning module, thereby lifting the optical scanning module upward and against the platen during a scanning operation.

According to the object of the invention, a first contacting manner of the adjusting means is provided. The rotated portion comprises: a shaft, penetrating a through hole of the roller; a swim, connected to one end of the shaft and firmly contacting with the first surface of the roller; a secured body, connected to the other end of the shaft; and a spring, received in a hole of the roller, and two ends of the spring respectively connected to the secured body and the roller. The elastic force of the spring pushes the secured body away from the roller so as to make the swim firmly contact with the first surface of the roller.

According to the object of the invention, a second contacting manner of the adjusting means is provided. The rotated portion comprises: a shaft, penetrating through a first hole of the roller; a swim, connected to one end of the shaft; a secured body, connected to the other end of the shaft; and a spring, received in a second hole of the roller, and two ends of the spring respectively connected to the swim and the secured body. An inward elastic force of the spring pulls the secured body and the swim toward the roller thereby forcing the swim and the secured body to firmly contact with the first surface and the second surface of the rollers, respectively.

According to the object of the invention, a third contacting manner of the adjusting means is provided. The rotated portion comprises: a shaft, penetrating a through hole of the roller; a swim, connected to one end of the shaft, and disposed on an opposite side of the first surface of the roller; a secured body, connected to the other end of the shaft; and a spring, received in a hole of the roller, and two ends of the spring respectively connected to the swim and the roller. The elastic force of the spring pushes the swim away from the roller so as to make the secured body firmly contact with the second surface of the roller.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (prior art) is an explosive view schematically showing a conventional structure of the contact image device (CIS) module and the carriage apparatus;

FIG. 2 schematically illustrates a side view of the optical scanning module, the carriage and the adjusting means in accordance with the preferred embodiment of the invention;

FIG. 3 is a partial enlarged sectional view of an adjusting means shown in FIG. 2;

FIG. 4 schematically illustrates the adjusting means of FIG. 2 from a bottom view angle;

FIG. 5 is a cross-sectional diagrammatic side view of the adjusting means taken along the section line A-A of FIG. 3;

FIG. 6A illustrates the first contacting manner of the adjusting means according to the invention;

FIG. 6B illustrates the second contacting manner of the adjusting means according to the invention; and

FIG. 6C illustrates the third contacting manner of the adjusting means according to the invention.

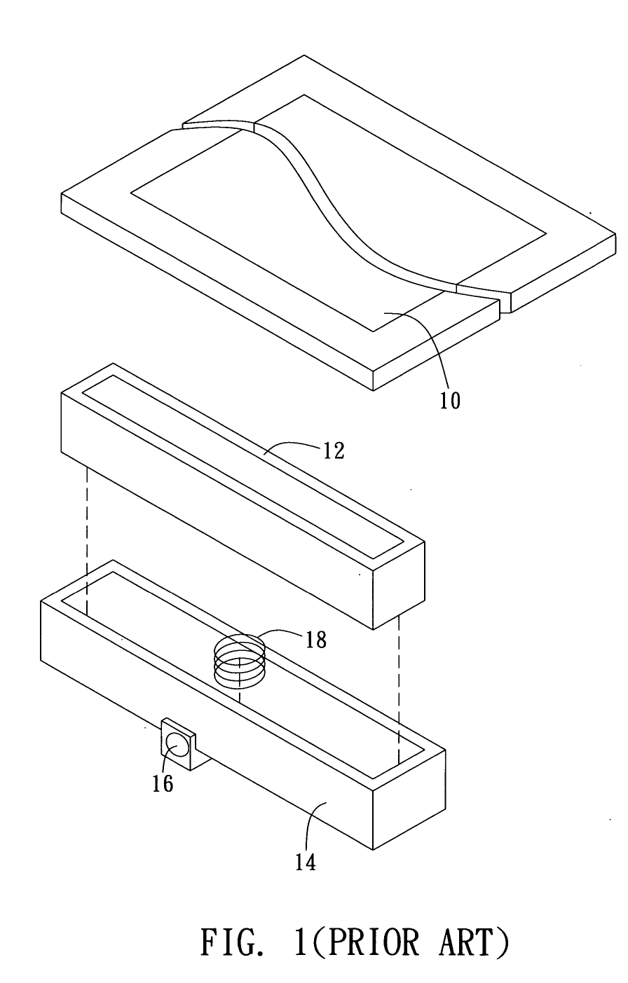

### DETAILED DESCRIPTION OF THE INVENTION

In the present invention, an adjusting means assembled with the carriage is mechanically constructed by using two objects in contact. When the first object rotates, the second object could be directly or indirectly rotated to provide an external force on the optical scanning module, thereby lifting the optical scanning module upwardly and against the transparent platen.

Additionally, the drawings used for illustrating the embodiments of the invention only show the major characteristic parts in order to avoid obscuring the invention. Accordingly, the specification and the drawing are to be regard as an illustrative sense rather than a restrictive sense.

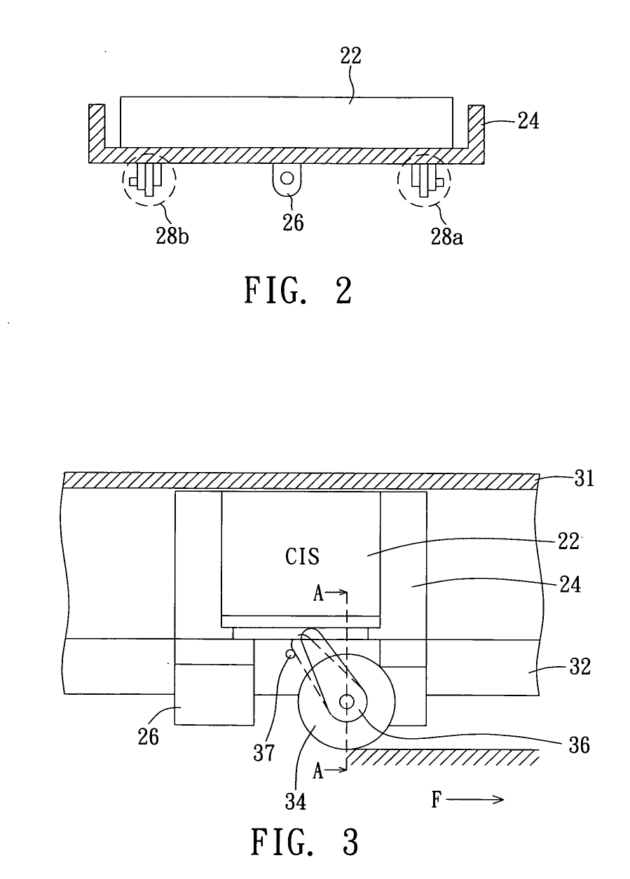

FIG. 2 schematically illustrates a side view of the optical scanning module, the carriage and the adjusting means in accordance with the preferred embodiment of the invention. The optical scanning module 22 is loaded in the carriage 24 which is mounted on a shaft (not shown) by a connecting means 16 and moved by the drive mechanism (not shown) along the scanning direction on the shaft. Also, there are two adjusting means 28a and 28b assembled on the both sides of the bottom surface of the carriage 24 for lifting the optical scanning module 22 up.

Although two adjusting means are illustrated in the preferred embodiment, it is not for the purpose of limiting the present invention. Noted that the object of lifting the optical scanning module can still be achieved even only one adjusting means is provided, for example, at or close to the center of the carriage.

FIG. 3 is a partial enlarged sectional view of an adjusting means shown in FIG. 2. As appears from FIG. 3, the carriage 24 is mounted on the shaft 32 through the connecting means 26, and moved on the shaft 32 along the scanning direction. The adjusting means at least comprises a roller 34 and a swim 36, which the swim 36 is able to press the roller 36 firmly after assembling. Also, the roller 34 touches the bottom surface of the scanner's housing, so that the roller 34 will simultaneously rotates with the movement of the carriage 24. When the optical scanning module 22 (loaded in the carriage 24) is moving along the scanning direction (as indicated by arrow F in FIG. 2), the rotating roller 34 will bring the firmly attached swim 36 up by doing the clockwise rotation simultaneously. The swim 36 is going to rotate until touching the bottom surface of the optical scanning module 22; consequently, the upward swim 36 forces the optical scanning module 22 up to contact the transparent platen 31.

After actual scanning operation, the carriage 24 is moved backward (opposite to the direction indicated by arrow F) to return to its original position, and the swim 36 is consequently doing the counterclockwise rotation. When the bottom surface of the optical scanning module 22 is not being touched by the swim 36, the external force vanishes and the optical scanning module 22 returns to its original position. Moreover, a fixing pin 37 could be optically constructed to maintain the swim 36 at a resting position. In practice the fixing pin 37 could be formed on the bottom housing of the carriage 24.

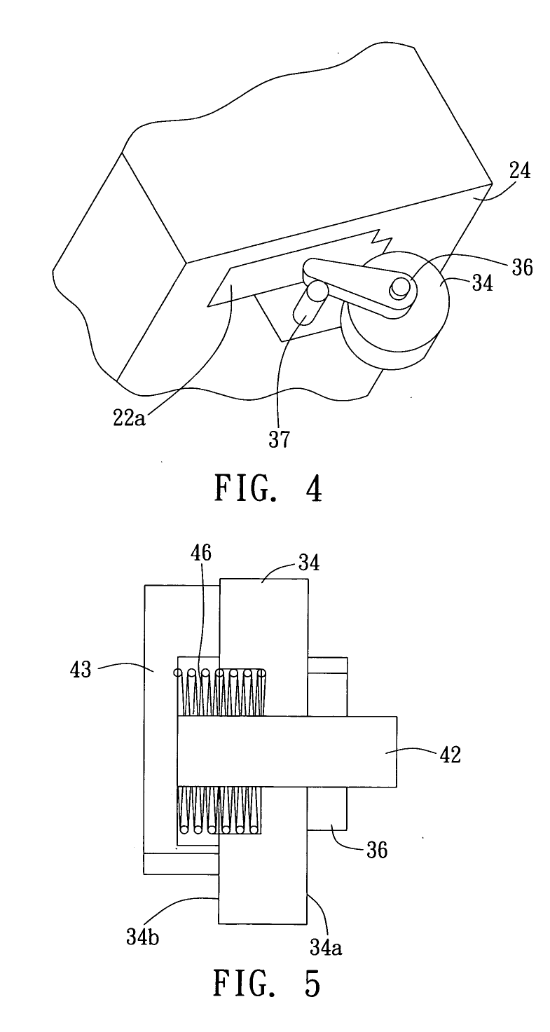

FIG. 4 schematically illustrates the adjusting means of FIG. 2 from a bottom view angle. The optical scanning module 22 is loaded in the carriage 24. In practice an opening of the carriage 24 would be optimal formed to expose a partial of the bottom surface 22a of the optical scanning module 22 for being touched by the swim 36.

FIG. 5 is a cross-sectional diagrammatic side view of the adjusting means taken along the section line A-A of FIG. 3. The roller 34 has a first surface 34a and a second surface 34b. The swim 36 tightly presses on the first surface 34a of the roller 34. The adjusting means further has a shaft 42 penetrating the roller 34, and one end of the shaft 34 is connected to the swim 36. In practice the shaft 42 and the swim 36 could be integrated as a whole. When the roller 34 rotates, friction between the first surface 34a of the roller 34 and the swim 36 in contact resists the relative motion of the roller 34 and swim 36 thereby simultaneously bringing the swim 36 upward with the rotating roller 34 to lift the optical scanning module 22.

In the embodiment, the other end of the shaft 42 is connected to a secured body 43 that tightly presses on the second surface 34b of the roller 34. Therefore, friction between the second surface 34b of the roller 34 and the secured body 43 also makes the secured body 43, the shaft 42 and the swim 36 rotate with the rotating roller 34.

Moreover, a spring 46 could be preferably added between the roller 34 and the secured body 43, for preventing the secured body 43 away from the roller 34 and enhancing friction between thereof. Alternatively, the spring 46 could be compressed between the roller 34 and the secured body 43 to push the secured body 43 outwardly, thereby making the swim 36 tightly press on the first surface 34a of the roller 34.

In this embodiment, it is very beneficial for the rotated swim 36 of the adjusting means to make the swim 36 and the secured body 43 tightly contact with the first surface 34a and the second surface 34b of the roller 34, respectively. When the roller 34 is rotating, friction existing on two sides of the roller 34 simultaneously brings the swim 36 into a rotating situation until the swim 36 touches the bottom surface 22a of the optical scanning module 22. During a scanning operation, the rollers keeps rotating with the movement of the carriage 24, so that the swim 36 continuously push the optical scanning module 22 upwardly and against the transparent platen 31 to acquire the optical image of the to be scanned document.

Although friction existing at two different places (i.e. between the roller 34 and the swim 36, and between the roller 34 and the secured body 43) are constructed in the preferred embodiment (as illustrated in FIG. 3, FIG. 4 and FIG. 5), only one contacting friction would be applicable in practice to accomplish the purpose of lifting the optical scanning module 22. There are three tightly contacting manners illustrated below.

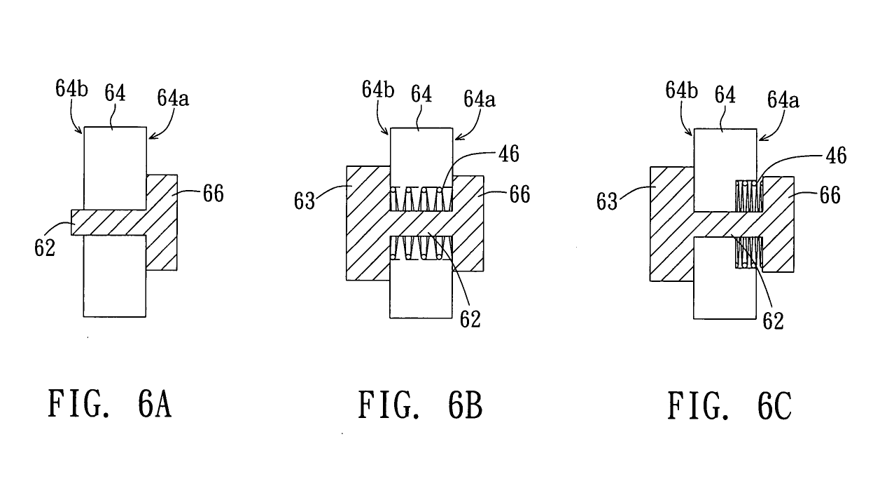

FIG. 6A illustrates the first contacting manner of the adjusting means according to the invention. The shaft 62 penetrates through the roller 64 in the center, and one end of the shaft 62 is connected to the swim 66 as a whole. The roller 64 has a first surface 64a and a second surface 64b. The swim 66 firmly presses on the first surface 64a of the roller 64. When the roller 64 is rotating, friction between the first surface 64a of the roller 64 and the swim 66 makes the swim 36 rotate, thereby lifting the optical scanning module 22 up and against the transparent platen 31. Also, it would be practically to add a securing means on the other end of the shaft 62, for example, an E-ring, for the purpose of preventing the shaft 62 as well as the swim 66 apart from the roller 64.

FIG. 6B illustrates the second contacting manner of the adjusting means according to the invention. The secured body 63 and the swim 66 firmly contact with the second surface 64b and the first surface 64a of the rollers 64, respectively. When the roller 64 rotates, not only the friction existing on the right side of the roller 64 makes the swim 66 rotate but also the friction existing on the left side of the roller 64 brings the secured body 63 into a rotating movement. The preferred embodiment (FIG. 3, FIG. 4 and FIG. 5) is one illustration of the second contacting manners of the adjusting means. Also, there is a hole through the roller 64 for receiving the spring 46, and two ends of the spring 46 are connected to the secured body 63 and the swim 66. An inward elastic force of the spring 46 pulls the secured body 63 and the swim 66 toward the roller 64 so that the secured body 63 and the swim 66 are forced to firmly contact with the second surface 64b and the first surface 64a of the rollers 64, respectively. Moreover, at least one of the secured body 63 and the swim 66 is able to slide on the shaft 62, and a round hole thereof is preferably constructed for receiving a non-round shaft 62.

FIG. 6C illustrates the third contacting manner of the adjusting means according to the invention. The secured body 63 firmly presses on the second surface 64b of the roller 64 but the swim 66 doesn't entirely contact with the first surface 64a of the roller 64. The hole in the roller 64 for receiving the spring 46 is constructed close to the swim 66. An elastic force of the spring 46 pushes the swim 66 away from the roller 64 so as to make the secured body 64 firmly attach on the second surface 64b of the roller 64. When the roller 64 rotates, friction between the roller 64 and the secured body 63 causes the secured body 63 to turn, and simultaneously brings the swim 66 into a rotating situation via the shaft 62.

According to the aforementioned description, one of two objects in contact rotates simultaneously makes the other rotates, due to friction between two objects. When the roller (the first object) rotates, the swim (the second object, directly contacting with the first object) could be directly rotated, or indirectly brought into a rotating movement (via the secured body contacting with the first object). Additionally, roughing the surfaces in contact could enhance friction between the first and the second objects.

Compared to the conventional design that installs a spring between the carriage and the optical scanning module, it is easy for the adjusting means disclosed herein to assemble with the carriage and to keep the optical scanning module in balance. Also, the mechanical construction of the adjusting means according to the invention has a long useful life.

While the invention has been described by way of examples and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A scanning apparatus, comprising:
a platen for placing a to-be-scanned document;
an optical scanning module, disposed under the platen for scanning and acquiring an scanned image of the to-be-scanned document; and
a carriage for carrying the optical scanning module to move backward and forward in the scanning apparatus, the carriage having an adjusting means to change a position of the optical scanning module, the adjusting means comprising:
a roller, having a first surface and a second surface, and rotated with a movement of the carriage; and
a rotated portion, firmly contacting with the roller;
when the roller rotating, friction between the rotated portion and the roller making the rotated portion rotate until touching the optical scanning module, thereby lifting the optical scanning module upward and against the platen during a scanning operation.

2. The scanning apparatus according to claim 1, wherein the rotated portion has a shaft penetrating through a hole of the roller in a center, and one end of the shaft is connected to a swim, and the swim firmly contacts with the first surface of the roller.

3. The scanning apparatus according to claim 2, wherein the shaft and the swim are integrated as a whole.

4. The scanning apparatus according to claim 2, wherein a securing means is added on the other end of the shaft for preventing the swim apart from the roller.

5. The scanning apparatus according to claim 4, wherein the securing means is an E-ring.

6. The scanning apparatus according to claim 2, wherein the other end of the shaft is connected to a secured body, and the secured body firmly contacts with the second surface of the roller.

7. The scanning apparatus according to claim 6, wherein the adjusting means has a spring, and two ends of the spring are respectively connected to roller and the secured body.

8. The scanning apparatus according to claim 6, wherein the shaft, the swim and the secured body are integrated as a whole.

9. The scanning apparatus according to claim 1, wherein the rotated portion comprises:
a shaft, penetrating through a first hole of the roller;
a swim, connected to one end of the shaft;
a secured body, connected to the other end of the shaft; and
a spring, received in a second hole of the roller, and two ends of the spring respectively connected to the swim and the secured body,
wherein an inward elastic force of the spring pulls the secured body and the swim toward the roller thereby forcing the swim and the secured body firmly to contact with the first surface of the roller and the second surface of the roller, respectively.

10. The scanning apparatus according to claim 9, wherein one of the secured body and the swim is able to slide on the shaft.

11. The scanning apparatus according to claim 1, wherein the rotated portion comprises:
a shaft, penetrating a through hole of the roller;
a swim, connected to one end of the shaft, and disposed on an opposite side of the first surface of the roller;
a secured body, connected to the other end of the shaft; and
a spring, received in a hole of the roller, and two ends of the spring respectively connected to the swim and the roller,
wherein an elastic force of the spring pushes the swim away from the roller so as to make the secured body firmly contact with the second surface of the roller.

12. The scanning apparatus according to claim 1, wherein the adjusting means has a fixing pin for maintaining the rotated portion at a resting position.

13. The scanning apparatus according to claim 1, wherein an opening is formed on the carriage to expose a partial of a bottom surface of the optical scanning module for being directly touched by the rotated portion.

14. The scanning apparatus according to claim 1, wherein the adjusting means is disposed at or close to a center of a bottom surface of the carriage.

15. The scanning apparatus according to claim 1, wherein two sets of the adjusting means are disposed at two ends of the carriage, respectively.

16. The scanning apparatus according to claim 1, wherein the optical scanning module has a contact image sensor (CIS).
